(19) United States
(12) Patent Application Publication
(10) Pub. No.: US 2018/0333930 A1
(43) Pub. Date: Nov. 22, 2018

(54) MOLD DEVICE WITH AN AIR VENTING STRUCTURE

(71) Applicant: Pou Chen Corporation, Chang Hwa Hsien (TW)

(72) Inventor: Wei-Lan Liang, Chang Hwa Hsien (TW)

(73) Assignee: Pou Chen Corporation, Chang Hwa Hsien (TW)

(21) Appl. No.: 15/975,833

(22) Filed: May 10, 2018

(30) Foreign Application Priority Data
May 19, 2017 (TW) 106116578

(51) Int. Cl. B29D 35/12

(52) U.S. Cl. CPC B29D 35/128; B29D 35/122

(57) ABSTRACT

A mold device includes first and second molds matched and engaged with each other at first and second curved major surfaces thereof to define a cavity between first and second matched portions. The molds respectively have first and second step portions surrounding the matched portions and spaced apart from the major surfaces in a height direction so as to define an air venting channel that is in air communication with the cavity and the ambient air. With such construction, the mold device is easy to fabricate and has a fewer number of components, thereby simplifying the manufacturing process and reducing the manufacturing cost.

### CROSS-REFERENCE TO RELATED APPLICATION

This application claims priority of Taiwanese Patent Application No. 106116578, filed on May 19, 2017.

### FIELD

The disclosure relates to a mold device, and more particularly to a foaming mold device with an air venting structure for forming a shoe sole.

### BACKGROUND

Referring to FIG. 1, a conventional shoe mold structure 1 as disclosed in TW M309500 includes a lower mold 13, an upper mold 11 matched with and superimposed upon the lower mold 13 to cooperatively define a cavity 12 therebetween, and an air-tight member 14 disposed to keep an air-tight engagement between the upper and lower molds 11, 13. The upper mold 11 has a matched major surface 111 and a step portion 112 formed on the matched major surface 111. The lower mold 13 has a matched major surface 131 matched and engaged with the matched major surface 111 of the upper mold 11, and a step portion 133 formed on the matched major surface 131 and confronting the step portion 112 to cooperatively define a surrounding groove 132 that is in air communication with the cavity 12, and an air venting pipe 134 in air communication with the surrounding groove 132 and the ambient air. The air-tight member 14 is disposed between the matched major surfaces 111, 131. Thus, air within the cavity 12 can be vented from the surrounding groove 132 through the air venting pipe 134 during a foaming process.

However, in such a structure, the air venting pipe 134, which is formed within the mold or on the matched major surface 131 (or 111), is needed to be fabricated after formation of the lower mold 13 or the upper mold 11, thus rendering the fabrication process complicated and the manufacturing cost higher. Moreover, the air-tight member 14 is required to keep the air-tight engagement between the matched major surfaces 131, 111, and is liable to be deteriorated in a heated and pressurized process.

### SUMMARY

Therefore, an object of the disclosure is to provide a mold device with an air venting structure that can alleviate at least one of the drawbacks of the prior art.

According to the disclosure, the mold device includes a first mold and a second mold. The first mold has a first curved major surface, at least one first matched portion which is formed on the first curved major surface, and at least one first step portion which surrounds the first matched portion. The first step portion is spaced apart from the first curved major surface in a height direction of the first mold. The second mold has a second curved major surface which is configured to be matched and engaged with the first curved major surface, at least one second matched portion which is formed on the second curved major surface and which cooperates with the first matched portion to define a cavity, and at least one second step portion which surrounds the second matched portion and which is spaced apart from the second curved major surface in a height direction of the second mold. The second step portion is configured to cooperate with the first step portion to define an air venting channel that is in air communication with the cavity and the ambient air when the second curved major surface is matched and engaged with the first curved major surface.

With the first and second curved major surfaces and the first and second step portions formed thereon, the mold device is easy to fabricate and has a fewer number of components, thereby simplifying the manufacturing process and reducing the manufacturing cost.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary, partly sectioned view of a conventional shoe mold structure;

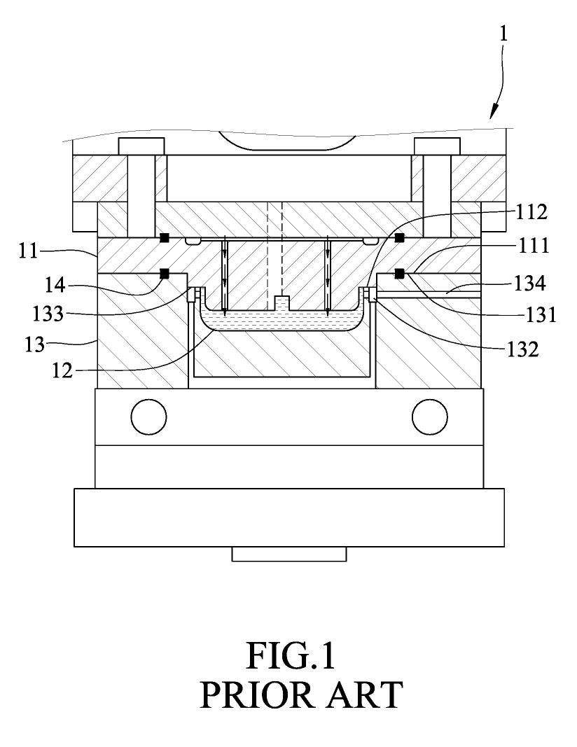

FIG. 2 is an exploded perspective view of an embodiment of a mold device according to the disclosure;

FIG. 3 is an exploded sectional view of the embodiment;

FIG. 4 is a front view of the embodiment;

FIG. 5 is a sectional view taken along line V-V of FIG. 4; and

FIG. 6 is an enlarged view of a portion of FIG. 5.

### DETAILED DESCRIPTION

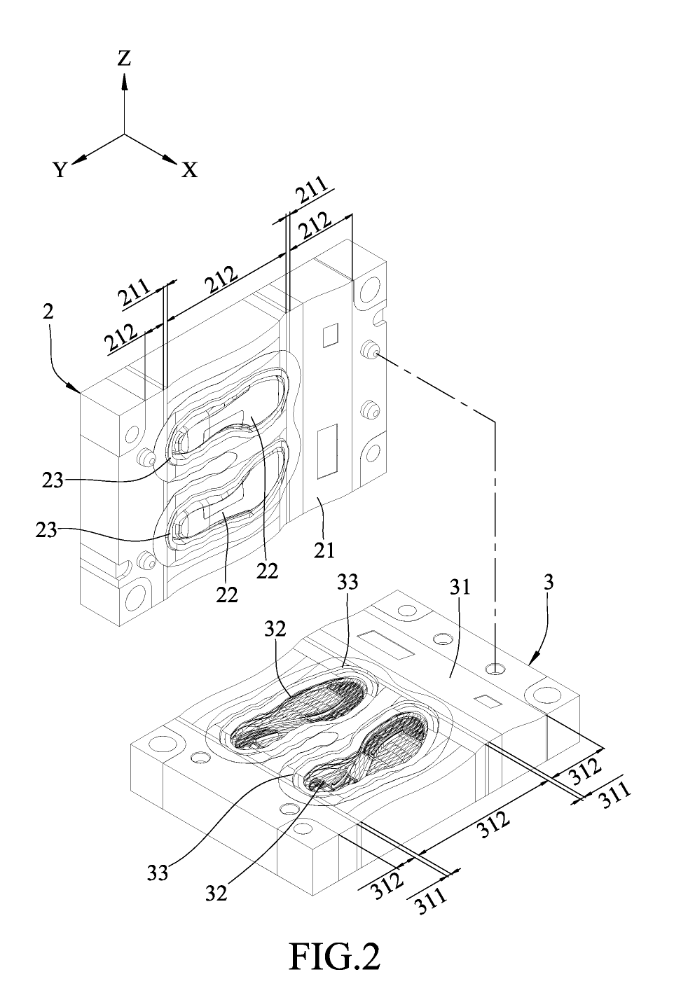

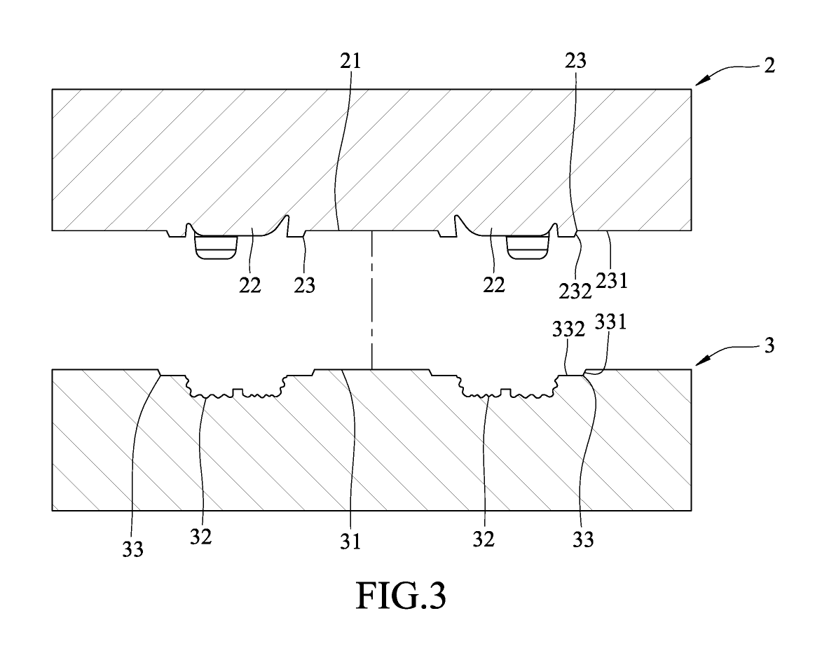

Referring to FIGS. 2 and 3, an embodiment of a mold device with an air venting structure according to the disclosure is utilized in a foaming process for making a shoe sole. The mold device includes a first mold 2 and a second mold 3.

The first mold 2 has a non-planar first curved major surface 21, two first matched portions 22 which are formed on the first curved major surface 21 and spaced apart from each other in a width direction (X) of the first mold 2, and two first step portions 23 which project from the first curved major surface 21 in a height direction (Z) of the first mold 2. Alternatively, the first mold 2 may have one first matched portion 22 and one first step portion 23.

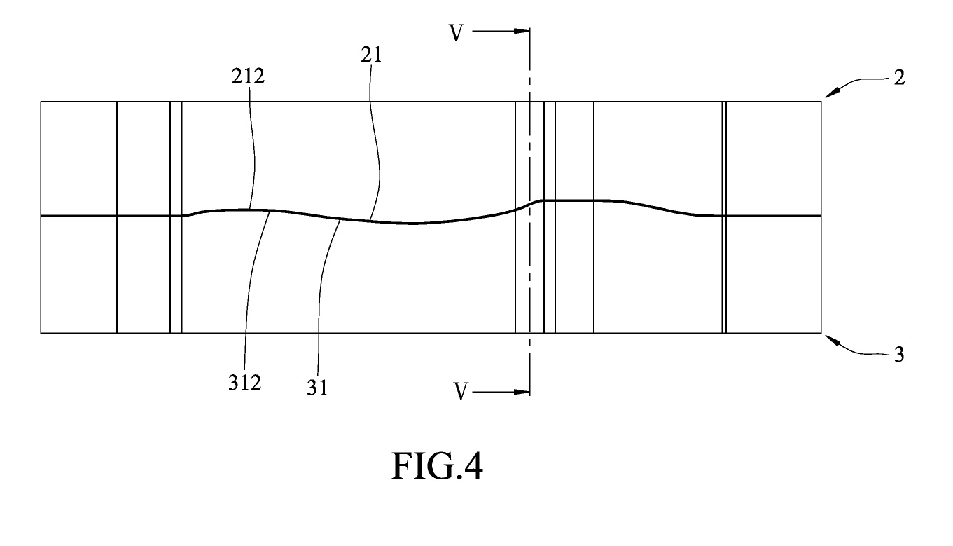

In this embodiment, the first curved major surface 21 extends to fluctuate in a lengthwise direction (Y) of the first mold 2 that is perpendicular to the height direction (Z) of the first mold 2 to define at least two different curvatures, as shown in FIG. 4. Specifically, the first curved major surface 21 has two first air-permeable surface segments 211 formed proximate to two opposite ends in the lengthwise direction (Y), and three first air-tight surface segments 212 formed distal from the first matched portions 22 relative to the air-permeable surface segments 211. The first air-tight surface segments 212 and the first air-permeable surface segments 211 may be arranged alternately in the lengthwise direction (Y).

Each of the first step portions 23 surrounds the respective first matched portion 22. Each of the first step portions 23 is spaced apart from the first curved major surface 21 in the height direction (Z). In this embodiment, each of the first step portions 23 has a slope segment 232 which extends and is inclined radially and outwardly from the first matched portion 22, and a height facing segment 231 which extends radially and outwardly from the slope segment 232 and which faces in the height direction (Z).

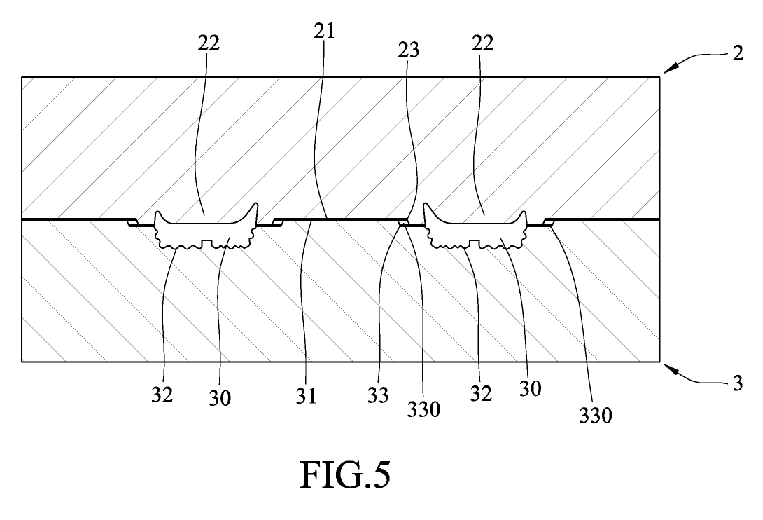

The second mold 3 has a non-planar second curved major surface 31 which is configured to be matched and engaged with the first curved major surface 21, two second matched portions 32 which are formed on the second curved major surface 21 and which respectively cooperate with the first matched portions 22 to define two cavities 30 (as shown in FIG. 5), and two second step portions 33 which are recessed from the second curved major surface 31 in a height direction (Z) of the second mold 3. Likewise, the second mold 3 may have one second matched portion 32 and one second step portion 33.

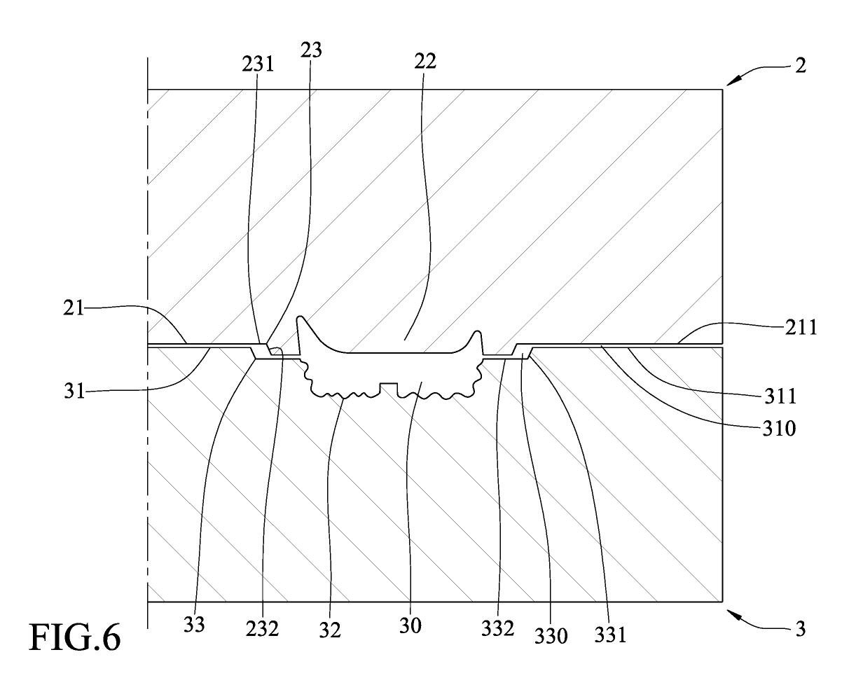

With reference to FIGS. 4 to 6, in this embodiment, the second curved major surface 31 extends to fluctuate in a lengthwise direction (Y) of the second mold 3 that is perpendicular to the height direction (Z) of the second mold 3 to define at least two different curvatures. The second curved major surface 31 has two second air-permeable surface segments 311 formed proximate to two opposite ends in the lengthwise direction (Y), and three second air-tight surface segments 312 formed distal from the second matched portions 32 relative to the air-permeable surface segments 311. The second air-tight surface segments 312 and the second air-permeable surface segments 311 may be arranged alternately in the lengthwise direction (Y). Each of the second air-permeable surface segments 311 is configured to cooperate with the respective first air-permeable surface segment 211 to define an air gap 310. Each of the second air-tight surface segments 312 is configured to be in air-tight engagement with the respective first air-tight surface segment 212.

Each of the second step portions 33 surrounds the respective second matched portion 32 and is spaced apart from the second curved major surface 31 in the height direction (Z). Each second step portion 33 is configured to cooperate with the respective first step portion 23 to define an air venting channel 330 when the second curved major surface 31 is matched and engaged with the first curved major surface 21. The air venting channel 330 is in air communication with each cavity 30 and the respective air gap 310 so as to establish an air flow route to the ambient air. In this embodiment, each second step portion 33 has a height facing segment 332 which extends radially and outwardly from the second matched portion 32 and which faces in the height direction (Z), and a slope segment 331 which extends and is inclined radially and outwardly from the height facing segment 332.

When the second curved major surface 31 is matched and engaged with the first curved major surface 21 in the height direction (Z), the second air-tight surface segments 312 are in air-tight engagement with the first air-tight surface segments 212, respectively, to block the air flow routes so as to permit air only to flow in the air gaps 310.

Thus, in a foaming process, the air within the cavities 30 can be dissipated to the air venting channels 330 and then vented out from the air gaps 310.

As illustrated, with the first and second curved major surfaces 21, 31 and the first and second step portions 23, 33 formed thereon, the mold device is easy to fabricate, has a fewer number of components, and dispenses with additional grooves or slots, thereby simplifying the manufacturing process and reducing the manufacturing cost. Moreover, with the first and second curved major surfaces 21, 31 configured to have the air-tight surface segments 212, 312 created by their different and matched curvatures, a great air-tight engagement between the first and second curved major surfaces 21, 31 is generated without an additional air-tight member mounted thereon, which reduces the number of the components and enhances the air-tight effect.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A mold device with an air venting structure, comprising:
a first mold having a first curved major surface, at least one first matched portion which is formed on said first curved major surface, and at least one first step portion which surrounds said first matched portion, said first step portion being spaced apart from said first curved major surface in a height direction of said first mold; and
a second mold having a second curved major surface which is configured to be matched and engaged with said first curved major surface, at least one second matched portion which is formed on said second curved major surface and which cooperates with said first matched portion to define a cavity, and at least one second step portion which surrounds said second matched portion and which is spaced apart from said second curved major surface in a height direction of said second mold, said second step portion being configured to cooperate with said first step portion to define an air venting channel that is in air communication with said cavity and the ambient air when said second curved major surface is matched and engaged with said first curved major surface.

2. The mold device as claimed in claim 1, wherein said first curved major surface extends to fluctuate in a lengthwise direction of said first mold that is perpendicular to the height direction of said first mold to define at least two different curvatures, and said second curved major surface extends to fluctuate in a lengthwise direction of said second mold that is perpendicular to the height direction of said second mold to define at least two different curvatures.

3. The mold device as claimed in claim 1, wherein said first curved major surface has at least one first air-permeable surface segment and at least one first air-tight surface segment formed proximal to and distal from said first matched portion, respectively, and said second curved major surface has at least one second air-permeable surface segment and at least one second air-tight surface segment formed proximal to and distal from said second matched portion, respectively, said second air-permeable surface segment being configured to cooperate with said first air-permeable surface segment to define an air gap that is in air communication with said venting channel and the ambient air so as to establish an air flow route when said second curved major surface is matched and engaged with said first curved major surface, said second air-tight surface segment being configured to be in air-tight engagement with said first air-tight surface segment to block the air flow route when said second curved major surface is matched and engaged with said first curved major surface.

4. The mold device as claimed in claim 1, wherein said first step portion projects from said first curved major surface, and said second step portion is recessed from said second curved major surface.

5. The mold device as claimed in claim 4, wherein said first step portion has a slope segment which extends and is inclined radially and outwardly from said first matched portion, and a height facing segment which extends radially and outwardly from said slope segment and which faces in the height direction of said first mold.

6. The mold device as claimed in claim 4, wherein said second step portion has a height facing segment which extends radially and outwardly from said second matched portion and which faces in the height direction of said second mold, and a slope segment which extends and is inclined radially and outwardly from said height facing segment.
